(19) United States
(12) Patent Application Publication
(10) Pub. No.: US 2007/0127075 A1
(43) Pub. Date: Jun. 7, 2007

(54) Method of reproducing color image

(75) Inventor: Yoshiaki Inoue, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/606,948

(22) Filed: Dec. 1, 2006

(30) Foreign Application Priority Data
Dec. 1, 2005 (JP) 2005-348476

(51) Int. Cl. H04N 1/40

(52) U.S. Cl. 358/3.01; 358/515

(57) ABSTRACT

FM screens are used for CMY-separations for which human visual sensitivity is relatively low. An AM screen is used for K-separation for which human visual sensitivity is high. The human visual sensitivity to one color is defined based on the contrast with the color white.

### BACKGROUND OF THE INVENTION

1. Field of the Invention

The present invention relates to a method of reproducing a color image, in which inputted image data having n gradation levels are compared with threshold matrices for a plurality of color separations, screens each having m (2≦m<n) levels for the color separations are generated, and the color image is reproduced by superimposing the generated screens for the color separations. The present method of reproducing a color image is preferably applicable to a printing-related apparatus (output system) such as a filmsetter, a platesetter, a CTP (Computer To Plate) apparatus, a CTC (Computer To Cylinder) apparatus, a DDCP (Direct Digital Color Proof) system, etc., an ink jet printer, or an electrophotographic printer, for example.

2. Description of the Related Art

Heretofore, when gradation (tone) reproduction is made by area modulation, so-called AM (Amplitude Modulation) screening and FM (Frequency Modulation) screening have been used in the art of printing. The AM screens are characterized by a screen ruling, a screen angle and a dot shape, and create gradations by varying the size of halftone dots. The FM screens create gradations by density of micro dots that have a constant size and are distributed pseudo-randomly (see Japanese Laid-Open Patent Publication No. 11-146189).

According to the disclosure therein, when a color image is reproduced by superimposing four screens for CMYK (Cyan, Magenta, Yellow and blacK)-separations, an FM screen with micro dots is used for the Y-separation, which has a relatively weak color. Then, AM screens having different screen angles by 300 from each other are used for the CMK-separations, which have relatively strong colors compared with the Y-separation. Thus, while the graininess of the image due to the use of the FM screen is minimized, a rosette pattern due to the use of the AM screens for the CMK-separations is properly arranged to reduce moiré patterns in the printed material of a digital gradation image.

A resolution of the screen will be explained later referring to Japanese Laid-Open Patent Publication No. 2005-252888.

Also, a required relationship between a screen ruling and a screen angle of an AM screen according to the present invention will be explained later referring to Japanese Laid-Open Patent Publication No. 2002-369017.

Recently, there has been a market need for a color image which is a high-resolution image with improved reproduction of details of the original image (e.g., objects in the image), which is a high-color-saturation image with vivid colors, and also which is a high quality image without almost any moiré pattern.

However, in the conventional method of reproducing a color image mentioned above, in which an AM screen is used for CMK-separations and an FM screen is used for a Y-separation, especially, it is almost impossible to obtain a high-resolution and high-color-saturation image as to the CMK-separations.

It is effective to use FM screens for CMYK-separations in order to obtain a high-resolution and high-color-saturation image. However, when FM screens are used for all the four general CMYK-separations, a reproduced image suffers some graininess and unevenness or irregularity of hue or shade in a large image having a constant density or the like.

On the other hand, when AM screens having general screen rulings are used for all the four CMYK-separations, it is almost impossible to obtain a high-resolution and high-color-saturation image, though a reproduced image does not suffer graininess or unevenness. Further, even if the screens for the CMK-separations have different screen angles by 300 from each other, a moiré pattern remains between the color Y and the colors CMK since the screen for the color Y cannot be arranged by 30° different from the screens for the colors CMK.

### SUMMARY OF THE INVENTION

It is an object of the present invention to provide a method of reproducing a dolor image, which can reproduce a high-resolution and high-color-saturation image whose unevenness or irregularity of hue or shade can be reduced.

Further, it is an object of the present invention to provide a method of reproducing a color image, which can reproduce a high-resolution and high-color-saturation image whose graininess, unevenness or irregularity of hue or shade can be reduced.

Furthermore, it is an object of the present invention to provide a method of reproducing a color image, which can reduce the unevenness or irregularity of hue or shade in a high-resolution AM screen.

According to the present invention, a screen is selected based on the fact that human visual sensitivity, that is, a degree to which a human perceives brightness when he/she sees a light, varies depending on the color of the light.

FIG. 1 illustrates spectral luminous efficiency 10 over the wavelength of light as defined by Commission Internationale de l'Eclairage (CIE). The spectral luminous efficiency 10 (also called as visual sensitivity characteristic) indicates human visual sensitivity, that is, a degree to which a human perceives brightness when he/she sees a light, which is normalized to a peak value of 1. The visual sensitivity characteristic 10 shows that human visual sensitivity has a peak of sensitivity around a green light having the wavelength of 555 nm, and that it is not axisymmetric but almost a normal distribution.

FIG. 2 illustrates that the visual sensitivity characteristic 10 shown in FIG. 1 and each color spectrum (reflectance) are superimposed. The color black (K), though it is not illustrated, has a reflectance of zero (reflectance=0).

When color reproduction is made by subtractive color mixture, separations for C, M and Y are generally used (CMY-separations). For a printing material, a separation for K is also used (K-separation). According to the present invention, gradation reproduction is supposed to be realized by area modulation, which uses color separations having high human visual sensitivity. The color separations having high human visual sensitivity means color separations whose colored halftone dots (on an AM screen) or colored dots (on an FM screen) for reproducing images have high contrast, with respect to a color of paper (the color white).

According to the present invention, there is provided a method of reproducing a color image, comprising the steps of: comparing inputted image data having n gradation levels with threshold matrices for a plurality of color separations; generating screens for the color separations, the screens each having m (2≦m<n) levels; and reproducing the color image by superimposing the generated screens for the color separations, wherein a color separation for which human visual sensitivity is high is selected from the color separations, the screen for the selected color separation is generated such that a resolution of the screen generated for the selected color separation is coarser than resolutions of screens for other color separations.

The resolution in this case means a screen ruling when an AM screen is used, or a pattern frequency when an FM screen is used. As to a pattern frequency in an FM screen, explanation will be made referring to Japanese Laid-Open Patent Publication No. 2005-252888 as follows.

An FM screen is generated by using a known algorithm. When a dot size is determined to be the size of a dot made up of one pixel or a dot made up of four pixels such as a 1-pixel (1×1 pixel) FM screen or a 4-pixel (2×2 pixels) FM screen, an array of thresholds of a threshold matrix is determined, thus determining an output quality. Then, only the dot size serves as a parameter for determining the quality of FM screens. For example, if a dot size is determined to be a large 3×3 pixel FM screen dot size with respect to an output system which is incapable of stably reproducing 2×2 pixel FM screen dots for highlight areas, then the resolution (referred to as pattern frequency or pattern resolution) for middle tones (10% to 50% as dot percentages) is lowered, resulting in a reduction in the quality of images.

FIG. 3 of the accompanying drawings shows a dot pattern 1 in a highlight area HL where the dot percentage of a 2×2 pixel FM screen is 5%, a dot pattern 2 in a middle tone area where the dot percentage of the 2×2 pixel FM screen is 50%, a dot pattern 3 in a highlight area HL where the dot percentage of a 3×3 pixel FM screen is 5%, and a dot pattern 4 in a middle tone area where the dot percentage of the 3×3 pixel FM screen is 50%.

FIG. 4 of the accompanying drawings shows a power spectrum generated when the dot pattern 2 of the 2×2 pixel FM screen shown in FIG. 3 is FFTed (Fast-Fourier-Transformed), and FIG. 5 of the accompanying drawings shows a power spectrum generated when the dot pattern 4 of the 3×3 pixel FM screen shown in FIG. 3 is FFTed.

In FIG. 3, at the dot percentage of 50% in the middle tone area, the dot pattern 2 of the 2×2 pixel FM screen suffers less graininess than the dot pattern 4 of the 3×3 pixel FM screen, but has the dot percentage less reproducible in the printed image. On the other hand, at the dot percentage of 50% in the middle tone area, the dot pattern 4 of the 3×3 pixel FM screen has a pattern frequency 6 of about 13 c/mm (cycles per millimeter) which is lower than the pattern frequency 5 of about 20 c/mm of the dot pattern 2 of the 2×2 pixel FM screen. The pattern frequencies 5, 6 which are of peak values are also called a peak spatial frequency fpeak. The lower the pattern frequency is, the coarser the resolution of the FM screen is.

That is, the resolution of a FM screen can be represented by a pattern frequency. Meanwhile, the resolution of an AM screen corresponds to a screen ruling as mentioned above.

To avoid confusion of similar terms, an output resolution, which is different from the resolution of the screen mentioned above, will be explained as follows. The output resolution of an output system such as an imagesetter, a CTP apparatus, etc. (the output resolution of an output system will hereinafter be referred to as output resolution R) is set to 2540 pixels/inch (=DPI (Dots Per Inch))=100 pixels/mm or 2400 DPI=94.488 pixels/mm, for example. With those settings, the dot size of the 1×1 pixel FM screen is 10 μm×10 μm when the output resolution R is 2540 DPI, or 10.6 μm×10.6 μm when the output resolution R is 2400 DPI. Also, the dot size of the 2×2 pixel FM screen is 20 μm×20 μm when the output resolution R is 2540 DPI, or 21.2 μm×21.2 μm when the output resolution R is 2400 DPI. Thus, the output resolution R is different from the pattern frequencies 5, 6.

These are the explanations as to the pattern frequency and the output resolution or the like, for representing the resolution of an FM screen.

According to the present invention, a color separation for which human visual sensitivity is high is selected from the color separations, for the selected color separation the screen having a coarse resolution is used compared with the resolutions of screens for other color separations. Thus, a color image can be reproduced, with its unevenness or irregularity of hue or shade less visible. That is, its unevenness or irregularity of hue or shade can be reduced.

In this case, the screens for the color separations may comprise FM screens. Thus, the unevenness or irregularity of hue or shade in a color image can be reduced, and a high-resolution and high-color-saturation image can be reproduced.

Further, even if the screens for the color separations comprise AM screens, the unevenness or irregularity of hue or shade in a color image can be reduced, and a high-resolution and high-color-saturation image can be reproduced.

Furthermore, the screen for the color separation for which human visual sensitivity is high may comprise an AM screen, and the screens for the other color separations may comprise FM screens. Thus, a color image can be reproduced, with its graininess or unevenness less visible. That is, its graininess or unevenness can be reduced, and a high-resolution and high-color-saturation image can be reproduced.

Specifically, a color separation for which human visual sensitivity is high will be explained below referring to FIG. 2. In such a color separation, colored halftone dots (drawn or blackened portion on an AM screen) or colored dots (on an FM screen) for reproducing images have high contrast with respect to a color of paper (the color white).

In FIG. 2, among the colors CMYK, a K-separation has no reflectance (distribution) with respect to the color white of paper all over the wavelengths, though not shown therein (reflectance=0). Thus, human visual sensitivity is the highest for the K-separation. Then, the human visual sensitivity is the second highest for an M-separation since the reflectance of a component at 550 nm, where human visual sensitivity is highest, is low. Subsequently, a C-separation and a Y-separation follow in this order. This concept can be applied to the case where another plurality of color separations are used similarly.

For example, it is preferable that the color separation for which human visual sensitivity is high comprises a K-separation when the K-separation is used for color reproduction with color separations such as CMK-separations or CMYK-separations.

When a screen for the K-separation for which human visual sensitivity is high is used for a screen for which a resolution is coarse, the unevenness or irregularity of hue or shade in the color image can be reduced.

When a screen for the K-separation is used as a screen for a color separation for which human visual sensitivity is high, and an FM or AM screen is used, the unevenness in the color image can be reduced.

Further, the screen for the color separation for which human visual sensitivity is high may comprise an AM screen for the K-separation, and the screens for the other color separations may comprise FM screens. Thus, the graininess, the unevenness in the color image can be reduced.

Furthermore, when the color separations for color reproduction may comprise CMY-separations but not a K-separation, a coarse-resolution screen may be used for the M-separation for which human visual sensitivity is high.

Further still, according to the present invention, when the color separations for color reproduction may comprise CMYKR(Red)G(Green)B(Blue)-separations, coarse-resolution screens may be used for the MKB-separations for which human visual sensitivity is high.

Still further, when the screen for the color separation for which human visual sensitivity is high comprises an AM screen, a screen ruling of the AM screen ranges from 175 to 300 LPI (Lines Per Inch).

The basis for the numerical limitation of the range from 175 to 300 LPI will be explained below.

In conventional offset printing, a dot gain amount (a dot percentage on a printing plate and a dot percentage on a printed material) is considered to be an indicator representing the easiness in printing (or occurrence probability of unevenness or irregularity of hue or shade). That is, it can be assumed that the larger the dot gain amount is, the larger the variation of the area is, when some condition such as a degree of ink viscosity is changed.

These can be explained considering a periphery length mentioned below. The periphery length represents the sum of the lengths of image-forming boundaries (white/black boundaries) per unit area of a dot pattern, including a halftone dot pattern in an AM screen and a dot pattern in an FM screen.

For example, as can be seen from dot patterns 100, 104 having the same area and the same image-forming percentage (dot percentage) shown in FIGS. 6A and 6B, the dot pattern 100 contains eight 1×1 pixel dots 102 each having a boundary length 4L where L represents the length of one side of each dot, and the dots 102 have a periphery length 32L and a total area 8L². The dot pattern 104 contains two 2×2 pixel dots 106 each having a boundary length 8L where 2L represents the length of one side of each dot, and the dots 106 have a periphery length 16L and a total area 8L².

Though the total area of the eight dots 102 of the dot pattern 100 and the total area of the two dots 106 of the dot pattern 104 are the same as each other, the dot patterns 100, 104 have different periphery lengths. Stated otherwise, though the dot pattern 100 and the dot pattern 104 have the same dot percentage, the sum of the lengths of image-forming boundaries per unit area of the dot pattern 104, i.e., the periphery length (also called as a dot periphery length) of the dot pattern 104, is one-half of the periphery length of the dot pattern 100.

When the dot pattern 100 having the periphery length 32L grows by a dot gain to have its dot percentage increased by +10%, the dot pattern 104 having the periphery length 16L is expected to have its dot percentage increased by +5%.

Thus, various variations indicative of printing stability such as a dot gain amount are considered to be essentially proportional to the periphery length of the dot pattern.

Further, as to halftone dots in an AM screen, various variations indicative of stability such as a dot gain amount are proportional to a screen ruling of the halftone dots.

Generally, if a dot pattern of a higher resolution is generated, then the number of pixels making up each dot is reduced, and the periphery length is increased, resulting in poorer various printing stabilities.

Therefore, provided that two dot patterns have the same resolution, one of the dot patterns which has a shorter dot periphery length can be a higher-performance dot pattern.

Generally, as to halftone dots in an AM screen, a standard screen ruling is 175 LPI. Further, an image can be printed without any major problems with a screen ruling up to around 300 LPI, if necessary conditions are controlled.

As shown in FIG. 7, the lower the screen ruling is, the more easily the image is printed (i.e., printability is great) and the less the image suffers unevenness. However, when the screen ruling is low, halftone dot structure becomes visible and the image is deteriorated. Therefore, it is almost impossible to print an image of high grade (having high-resolution and high-image-quality) when the screen ruling is less than 175 LPI. Further, in a high-quality FM screen, it is almost impossible to print an image since a periphery length thereof corresponds to a periphery length in an AM screen having 400 to 600 LPI (i.e., printability is poor).

Accordingly, it is preferable that a screen ruling ranges from 175 to 300 LPI when the screen for a color separation for which human visual sensitivity is high comprises an AM screen.

According to the present invention, a high-resolution and high-color-saturation image can be reproduced, and its unevenness or irregularity of hue or shade can be reduced.

Further, according to the present invention, a high-resolution and high-color-saturation image can be reproduced, and its graininess, unevenness or irregularity of hue or shade can be reduced.

Furthermore, according to the present invention, a color image can be reproduced by a high-resolution AM screen by which the image hardly suffers unevenness or irregularity of hue or shade.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a chart illustrating spectral luminous efficiency, which is obtained by normalizing a degree to which a human perceives brightness when he/she sees a light (human visual sensitivity);

FIG. 2 is a chart illustrating each color spectrum (reflectance);

FIG. 3 is a diagram illustrating dot patterns at dot percentages of 5% and 50% of 2×2 pixel FM screen and dot patterns at dot percentages of 5% and 50% of 3×3 pixel FM screen;

FIG. 4 is a diagram illustrating a power spectrum generated when the dot pattern at the dot percentage of 50% of the 2×2 pixel FM screen is processed by FFT;

FIG. 5 is a diagram illustrating a power spectrum generated when the dot pattern at the dot percentage of 50% of the 3×3 pixel FM screen is processed by FFT;

FIG. 6A is a diagram illustrating a periphery length of small dots;

FIG. 6B is a diagram illustrating a periphery length of large dots at the same dot percentage as with FIG. 6A;

FIG. 7 is a chart qualitatively illustrating advantageous effects and difficulty level of printing as to screen rulings;

FIG. 8 is a block diagram of a printing/platemaking system;

FIG. 9 is a diagram illustrating screens according to a Comparative Example 1 and an Example 1;

FIG. 10 is a diagram illustrating screens according to the Comparative Example 1 and Examples 2 and 3; and

FIG. 11 is a diagram illustrating screens according to a Comparative Example 2 and an Example 4.

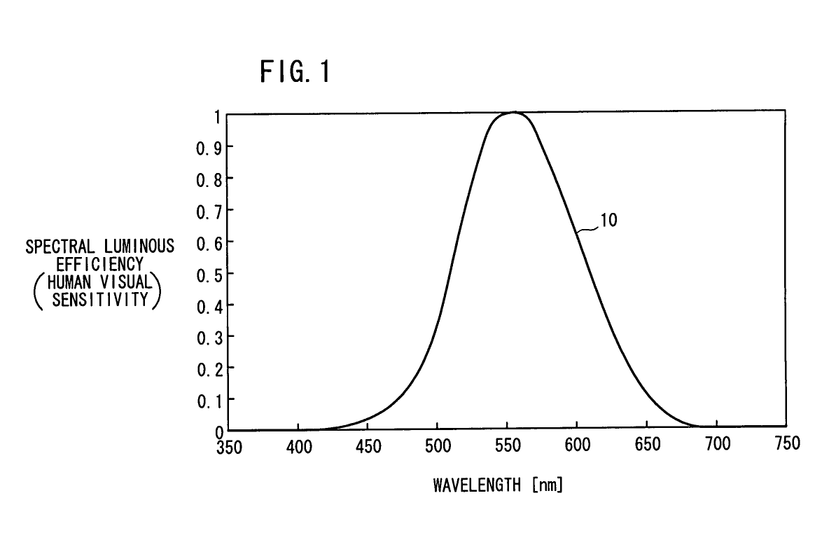

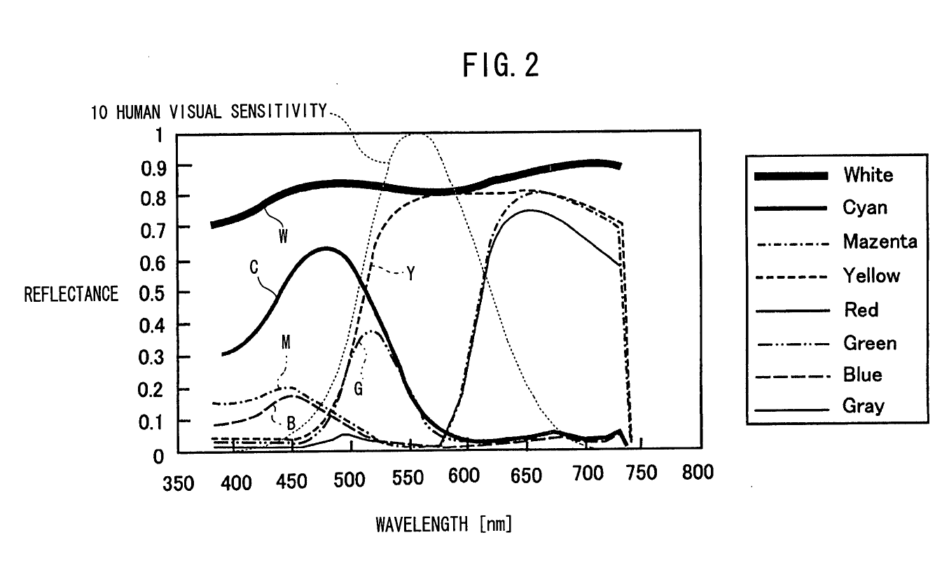

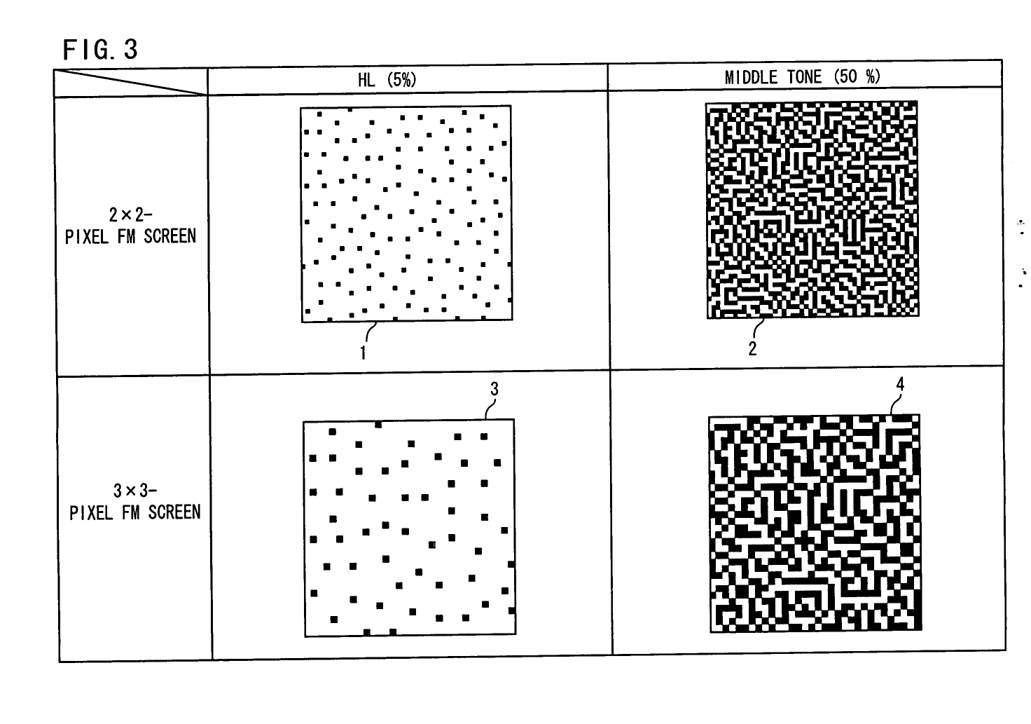

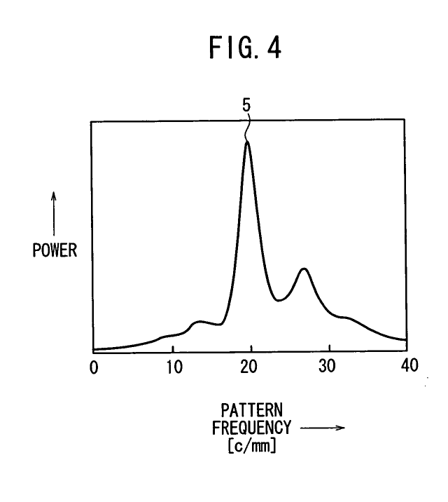

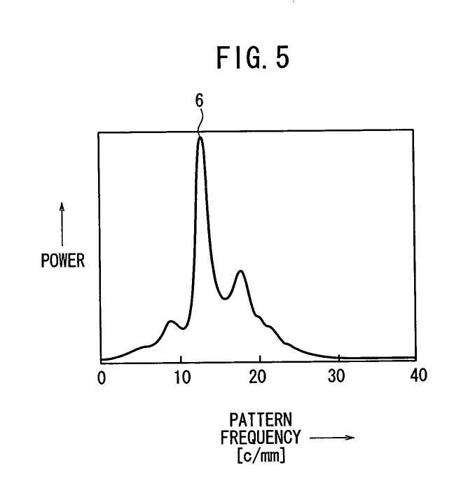

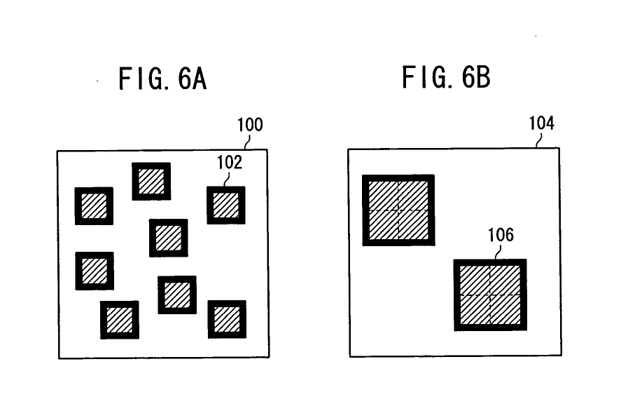

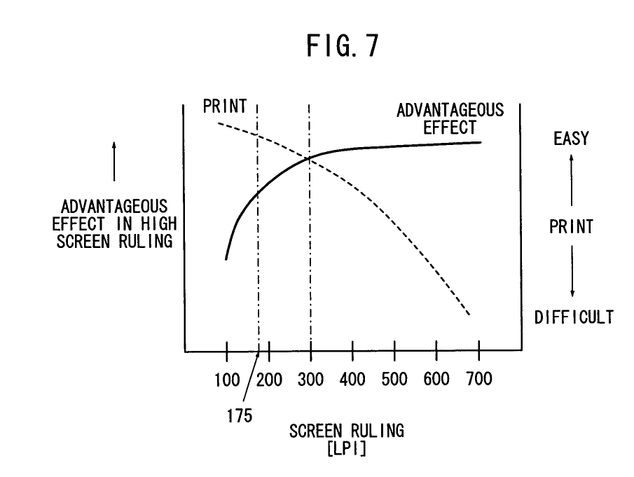

### DESCRIPTION OF THE PREFERRED EMBODIMENTS

Hereinafter, embodiments of the present invention will be described with reference to the drawings.

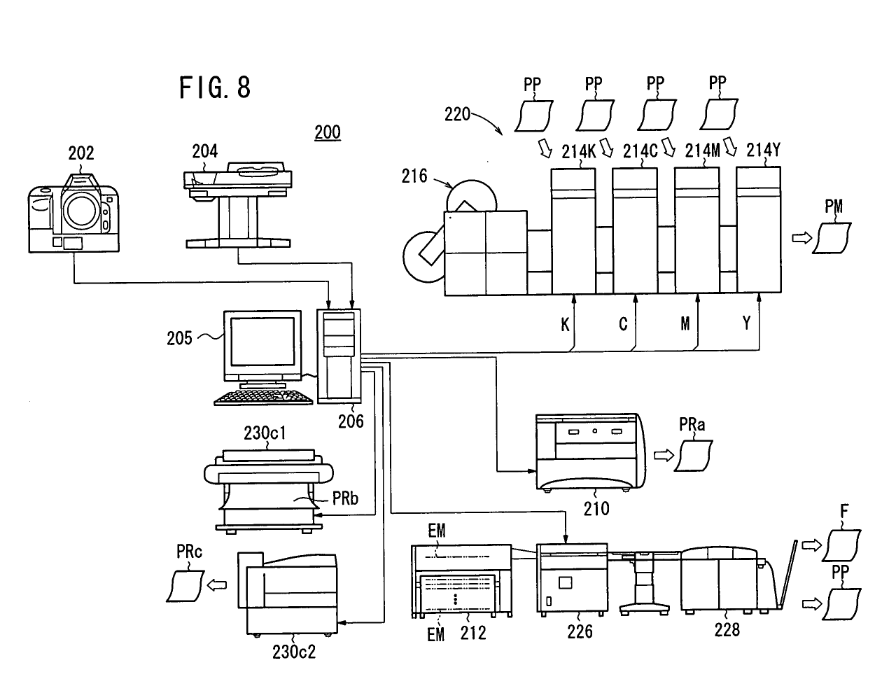

FIG. 8 illustrates a printing/platemaking system 200 to which a method of reproducing a color image is applied according to the present invention.

In the printing/platemaking system 200, RGB image data of an object (an original image) captured by a digital camera 202 as an image capturing unit or RGB image data of the original image (or CMYK image data) read by a plate input machine 204 as a scanner (image reader) are supplied to an RIP (Raster Image Processor) 206, which converts the RGB image data into CMYK image data temporarily.

The RIP 206 stores threshold matrix data for respective color separations in view of both AM and FM screens. The RIP 206 is connected to a personal computer 205 for setting output conditions for selecting a desired threshold matrix such as a screen ruling, a screen angle, a pattern frequency and whether an AM screen or an FM screen. The personal computer 205 is also used for checking an image or the like.

The RIP 206 compares the CMYK image data and the corresponding CMYK threshold matrices with each other, and converts the CMYK image data into CMYK dot pattern data. Each of the CMYK image data has n gradation levels (a continuous gradation, e.g., n=256). Image data having a continuous gradation is defined as image data obtained such that a continuous gradation (tone) image is inputted by an input apparatus such as an image capturing unit or a plate input machine, and that the inputted data is A/D converted. The CMYK dot pattern data correspond to CMYK screens each having m (2≦m<n) levels.

The CMYK dot pattern data are then sent to a DDCP (Direct Digital Color Proofer) 210, which produces a print proof PRa on a sheet of paper. The DDCP 210 allows the operator to confirm noise components and printing quality on the print proof PRa before the image data are processed by a printing press 220. The sheet of paper used by the DDCP 210 may be a sheet of printing paper used by the printing press 220.

The RIP 206 delivers the CMYK dot pattern data to a color ink jet printer 230c1 which simply produces a printing proof PRb on a sheet of paper, or a color electrophotographic printer 230c2 which simply produces a printing proof PRc on a sheet of paper.

The CMYK dot pattern data are also sent to an exposure unit 226 which serves as a filmsetter or a platesetter. The exposure unit 226 makes up the output system of the CTC apparatus or the like. If the exposure unit 226 is a filmsetter, the automatic developing machine 228 generates a film F. The film F is superposed on a printing plate material, and exposed to light by a planar exposure unit (not shown), producing a printing plate PP. If the exposure unit 226 is a platesetter, then the automatic developing machine 228 directly outputs a printing plate PP. The exposure unit 226 is supplied with printing plate materials EM or the like from a magazine 212 of photosensitive materials (including printing plate materials).

CMYK printing plates PP are mounted on plate cylinders (not shown) in a K-separation printer 214K, a C-separation printer 214C, an M-separation printer 214M, and a Y-separation printer 214Y of the printing press 220. In the K-separation printer 214K, the C-separation printer 214C, the M-separation printer 214M, and the Y-separation printer 214Y, the CMYK printing plates PP are pressed against a sheet of printing paper supplied from a printing paper supply unit 216 to transfer the inks to the sheet of printing paper, thereby producing a printed material PM on which a color image is reproduced. If the printing press 220 is configured as a CTC apparatus, then the RIP 206 supplies the CMYK dot pattern data directly through a communication link, and the printing plates mounted on the plate cylinders are exposed to record image data and then developed directly into printing plates PP.

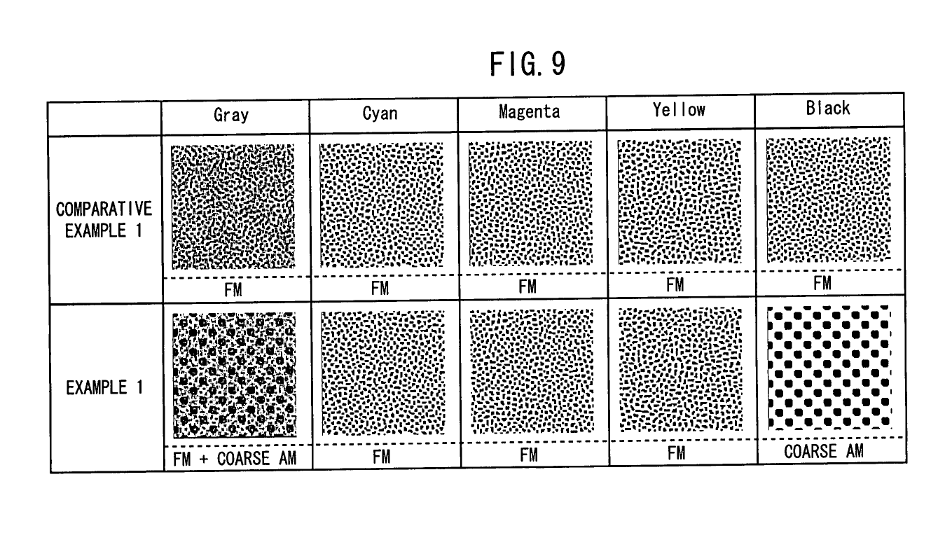

FIGS. 9 through 11 illustrate output examples, in which the columns indicated “Black” show screens for K-separation, the columns indicated “Yellow” show screens for Y-separation, the columns indicated “Magenta” show screens for M-separation, the columns indicated “Cyan” show screens for C-separation, and the columns indicated “Gray” show color images obtained by superimposing the CMYK-separations. Each of the CMYK-separations has a dot percentage of 30%. For all the CMYK-separations, each of the input image data has 256 gradation levels (n=256). Hereinafter, visual evaluation of these color images will be described. For the sake of simplicity, all the images in FIGS. 9 through 11 are indicated as black and white images, which may include images in a printed material and/or simulated images on a display. While it should be noted that visual evaluation or effect might be different from the case when they are seen in black and white images, the following evaluation is based on color images.

In an upper row in a table of FIG. 9, a Comparative Example 1 used high-resolution FM screens for all the CMYK screens, in which the pattern frequency was about 18 c/mm. Depending on the output conditions, some of the color images in “Gray” suffered the graininess, the unevenness or irregularity of hue or shade, as to K-separation.

In a lower row in the table of FIG. 9, an Example 1 used a coarse-resolution AM screen having a low screen ruling for the K-separation, for which human visual sensitivity is high compared with the other CMY-separations. In the AM screen of the Example 1, the screen ruling was 175 LPI and the screen angle was 45°. The screens for CMY-separations were the same as those for the CMY-separations of the Comparative Example 1. In the color image indicated as “FM+coarse AM”, the graininess, the unevenness or the moiré was not found. This color image had high-resolution and high-color-saturation.

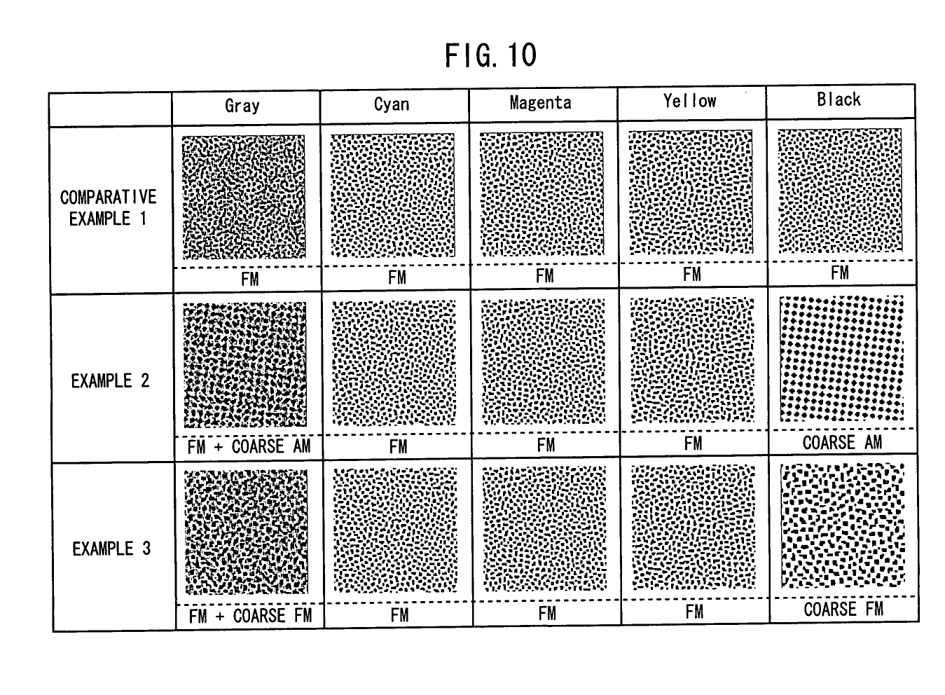

In an upper row in a table of FIG. 10, the Comparative Example 1 in FIG. 9 is illustrated again. In a middle row in the table of FIG. 10, an Example 2 used a coarse-resolution AM screen having a relatively low screen ruling for the K-separation, for which human visual sensitivity is high compared with the other CMY-separations. In the AM screen of the Example 2, the screen ruling was 300 LPI and the screen angle was 82.5°. The screens for CMY-separations were the same as those for the CMY-separations of the Comparative Example 1. In the color image indicated as “FM+coarse AM”, the graininess, the unevenness or the moiré was also not found. This color image had high-resolution and high-color-saturation.

In a lower row in the table of FIG. 10, an Example 3 used a coarse-resolution FM screen for the K-separation, for which human visual sensitivity is high compared with the other CMY-separations. In the FM screen for the K-separation of the Example 3, the pattern frequency was about 12 c/mm. The screens for CMY-separations are the same as those for the CMY-separations of the Comparative Example 1. In the color image indicated as “FM+coarse FM”, the graininess, the unevenness or the moiré was also not found. This color image had high-resolution and high-color-saturation.

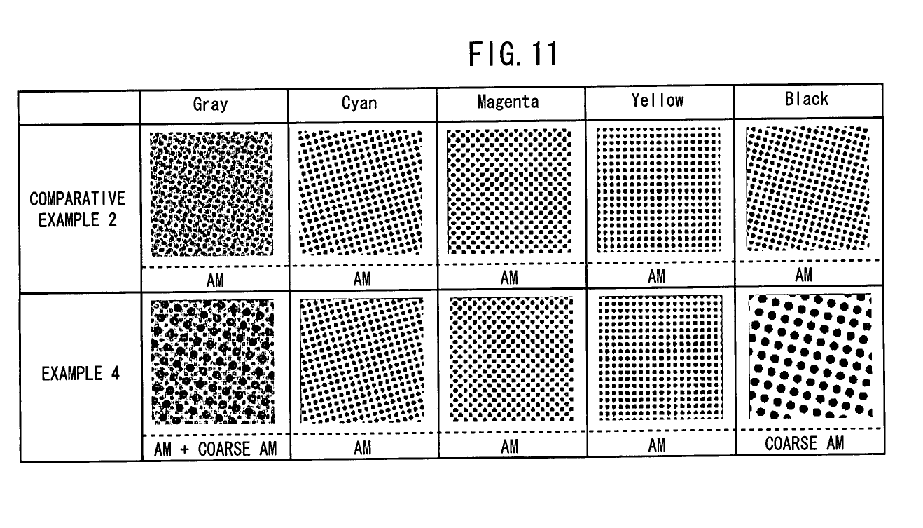

As shown in an upper row in a table of FIG. 11, a Comparative Example 2 used high-resolution AM screens for all the CMYK screens, in which the screen ruling was 350 LPI and the screen angle for the C-separation was 150, the screen angle for the M-separation was 45°, the screen angle for the Y-separation was 0° and the screen angle for the K-separation was 750. Depending on the printing conditions, some of the color images in “Gray” suffered the unevenness or irregularity of hue or shade, as to K-separation.

As defined in Japanese Laid-Open Patent Publication No. 2002-369017, in the Comparative Example 2, at least the screen angles for the CMK-separations were irrational tangent angles. Further, screen rulings and screen angles of the CMK-separations were set such that the period and the angle of a moiré pattern generated when two of the CMK-separations were superimposed substantially corresponded to a screen ruling and a screen angle of the remaining one of the CMK-separations. Furthermore, the following relationship was established:
d3·cos θ3=d1·cos θ1−d2·cos θ2
d3·sin θ3=d2·sin θ2−d1·sin θ1
where d1, d2 and d3 are the screen rulings of the CMK-separations, respectively; and θ1, θ2 and θ3 are the screen angles of the CMK-separations, respectively (θ1<θ3<θ2).

In a lower row in the table of FIG. 11, an Example 4 used an AM screen having the screen ruling of 175 LPI that was coarser than the screen ruling of 350 LPI for the K-separation of the Comparative Example 2. In this case, when the screen ruling and the screen angle of the Comparative Example 2 were dk and θk, the screen ruling and the screen angle for the K-separation of the Example 4 were set as dk/L and θk, respectively (corresponding to L=2 in the Example 4).

In the lower row in the table of FIG. 11, as to the color image indicated as “AM+coarse AM”, the Example 4 used a coarse-resolution AM screen having a relatively low screen ruling for the K-separation, for which human visual sensitivity is high compared with the other CMY-separations. In the AM screen for the K-separation of the Example 4, the screen ruling was 175 LPI, which is lower than the other ones for the CMY-separations of the Comparative Example 2. The screens for CMY-separations were the same as those for the other CMY-separations of the Comparative Example 2. In the color image indicated as “AM+coarse AM”, the graininess or the unevenness was not found.

Although certain preferred embodiments of the present invention have been shown and described in detail, it should be understood that various changes and modifications may be made therein without departing from the scope of the appended claims.

What is claimed is:

1. A method of reproducing a color image, comprising the steps of:
comparing inputted image data having n gradation levels with threshold matrices for a plurality of color separations;
generating screens for the color separations, the screens each having m (2≦m<n) levels; and
reproducing the color image by superimposing the generated screens for the color separations,
wherein a color separation for which human visual sensitivity is high is selected from the color separations, the screen for the selected color separation is generated such that a resolution of the screen generated for the selected color separation is coarser than resolutions of screens for other color separations.

2. A method according to claim 1, wherein the color separation for which human visual sensitivity is high comprises a K-separation.

3. A method according to claim 1, wherein the screens for the color separations comprise AM screens.

4. A method according to claim 1, wherein the screen for the color separation for which human visual sensitivity is high comprises an AM screen, a screen ruling of the AM screen ranges from 175 to 300 LPI.

5. A method according to claim 2, wherein the screen for the K-separation for which human visual sensitivity is high comprises an AM screen, a screen ruling of the AM screen ranges from 175 to 300 LPI.

6. A method according to claim 3, wherein a screen ruling of the screen for the color separation for which human visual sensitivity is high ranges from 175 to 300 LPI.

7. A method according to claim 1, wherein the screens for the color separations comprise FM screens.

8. A method according to claim 7, wherein the color separation for which human visual sensitivity is high comprises a K-separation.

9. A method according to claim 1, wherein the screen for the color separation for which human visual sensitivity is high comprises an AM screen, and the screens for the other color separations comprise FM screens.

10. A method according to claim 9, wherein the color separation for which human visual sensitivity is high comprises a K-separation.

11. A method according to claim 9, wherein a screen ruling of the screen for the color separation for which human visual sensitivity is high ranges from 175 to 300 LPI.

12. A method according to claim 10, wherein a screen ruling of the screen for the K-separation for which human visual sensitivity is high ranges from 175 to 300 LPI.

13. A method according to claim 1, wherein the color separations consist of CMY-separations but not a K-separation, and wherein the M-separation for which human visual sensitivity is high is selected, and a coarse-resolution screen is generated for the M-separation.

14. A method according to claim 1, wherein the color separations comprise CMYKR(Red)G(Green)B(Blue)-separations, and wherein the MKB-separations for which human visual sensitivity is high are selected, and coarse-resolution screens are generated for the MKB-separations.
